(19) United States
(12) Patent Application Publication
(10) Pub. No.: US 2004/0002882 A1
(43) Pub. Date: Jan. 1, 2004

(54) Computer program protection

(76) Inventor: John Aram Safa, Nottingham (GB)

Correspondence Address: SMITH-HILL AND BEDELL, 12670 N W BARNES ROAD, SUITE 104, PORTLAND, OR, 97229

(21) Appl. No.: 10/609,792

(22) Filed: Jun. 26, 2003

(30) Foreign Application Priority Data
Jun. 28, 2002 (GB) 0214943.3

(51) Int. Cl. G06F 17/60

(52) U.S. Cl. 705/7

(57) ABSTRACT

Executable software 30B is protected by inserting an additional block of code 50, immediately after the header 30A. The block 50 is executable to analyse all or part of the structure 30 to determine whether or not any change has been made to the structure after the creation of the structure. For example, a CRC value may be checked. When the software 30B is to be executed, the security block 50 executes first, to check if any changes have been made, such as by the effect of a virus. If this is detected, a compressed copy 52 is used to replace at least the program region 30B, prior to execution being handed to the block 30B.

The present invention relates to the protection of computer programs and in particular, but not exclusively, to protection against software viruses.

It is well known that software viruses represent a security threat to computer systems, in view of their potential to affect correct operation of the system. Various approaches have been used to seek to prevent problems of this type arising. These approaches can include the detection of patterns of code characteristic of known viruses, or detecting some of the effects of virus infection, such as modification of the size of files. Once a virus is detected, the user is normally alerted, to allow the virus to be removed. After the virus has been removed, the integrity of the remainder of the file may be in doubt.

The present invention provides a computer program structure including a program module which is executable, and protection means including a sensing module operable to analyse at least part of the program structure to determine whether or not any change has been made thereto, and a correction module operable to retrieve a further copy of the program module in the event that a change is detected, and to cause the further copy to be executed instead of the first module.

The sensing module may be operable to measure a parameter of the said part, for comparison with a parameter value measured previously. The parameter may be the size of the data representing the said part, or the size of a section of the said data. The parameter may be the location of a predetermined feature, such as an entry point for the program module. The parameter may be a characteristic value calculated from the code representing the said part, such as a cyclic redundancy check (CRC) value.

The correction module may include the said further copy. The said further copy may be held in compressed form within the correction module. The correction module may, in use, retrieve the further copy from a location remote from the machine on which the program module is to be executed. The further copy may, in use, be retrieved by means of data transmission over a network, such as a wireless network. The correction module preferably installs the further copy at a location alternative to the location of the program module.

The sensing module and/or the correction module may be incorporated with the program module to form a single procedure. The sensing module and/or correction module may be contained wholly or partly within a header to the procedure. The sensing module and/or correction module may be contained wholly or partly at empty locations within the program module. Preferably, all other empty locations are filled with meaningless data.

The invention also provides a method of executing a computer program, in which at least part of the copy of the program available for execution is analysed to determine whether or not any change has been made thereto, and in the event that a change is detected, a further copy of the program is retrieved and caused to be executed instead of the first copy.

Preferably a parameter of the said part is measured, for comparison with a parameter value measured previously. The parameter may be the size of the data representing the said part, or the size of a section of the said data. The parameter may be the location of a predetermined feature, such as an entry point for the program copy. The parameter may be a characteristic value calculated from the code representing the said part, such as a cyclic redundancy check (CRC) value.

The computer program may be associated with a correction module which includes the said further copy. The said further copy may be held in compressed form within the correction module. The correction module may retrieve the further copy from a location remote from the machine on which the program module is to be executed. The further copy may be retrieved by means of data transmission over a network, such as a wireless network. The correction module preferably installs the further copy at a location alternative to the location of the first copy.

A sensing module operable to determine whether or not any change has been made and/or the correction module may be incorporated within the program module to form a single procedure. The sensing module and/or correction module are preferably contained wholly or partly within a header to the procedure. The sensing module and/or correction module may be contained wholly or partly at empty locations within the procedure. Preferably, all other empty locations are filled with meaningless data.

In another aspect, the invention provides apparatus operable to create a computer program structure, the apparatus being operable to provide an executable program module and protection means which includes a sensing module operable to analyse at least part of the program structure to determine whether or not any change has been made thereto, and a correction module operable to retrieve a further copy of the program module in the event that a change is detected, and to cause the further copy to be executed instead of the first module.

The sensing module may be operable to measure a parameter of the said part, for comparison with a parameter value measured previously. The parameter may be the size of the data representing the said part, or the size of a section of the said data. The parameter may be the location of a predetermined feature, such as an entry point for the program module. The parameter may be a characteristic value calculated from the code representing the said part, such as a cyclic redundancy check (CRC) value.

The correction module may include the said further copy. The said further copy may be held in compressed form within the correction module. The correction module may retrieve the further copy from a location remote from the machine on which the program module is to be executed. The further copy may be retrieved by means of data transmission over a network, such as a wireless network. The correction module preferably installs the further copy at a location alternative to the location of the program module.

The sensing module and/or the correction module may be incorporated within the program module to form a single procedure. The sensing module and/or correction module may be contained wholly or partly within a header to the procedure. The sensing module and/or correction module may be contained wholly or partly at empty locations within the program module. Preferably, all other empty locations are filled with meaningless data.

In this aspect, the invention also provides a method of creating a computer program structure, in which an executable program module is provided and is associated with protection means which includes a sensing module operable to analyse at least part of the program module to determine whether or not any change has been made thereto, and a correction module operable to retrieve a further copy of the program module in the event that a change is detected, and to cause the further copy to be executed instead of the first module.

The sensing module may be operable to measure a parameter of the said part, for comparison with a parameter value measured previously. The parameter may be the size of the data representing the said part, or the size of a section of the said data. The parameter may be the location of a predetermined feature, such as an entry point for the executable part. The parameter may be a characteristic value calculated from the code representing the said part, such as a cyclic redundancy check (CRC) value.

The correction module may include the said further copy. The said further copy may be held in compressed form within the correction module. The correction module may retrieve the further copy from a location remote from the machine on which the program module is to be executed. The further copy may be retrieved by means of data transmission over a network, such as a wireless network. The correction module is preferably operable to install the further copy at a location alternative to the location of the first module.

The sensing module and/or the correction module may be incorporated within the program module to form a single procedure. The sensing module and/or correction module may be contained wholly or partly within a header to the procedure. The sensing module and/or correction module may be contained wholly or partly at empty locations within the program module. Preferably, all other empty locations are filled with meaningless data.

Examples of the prevent invention will now be described in more detail, by way of example only, and with reference to the accompanying drawings, in which:

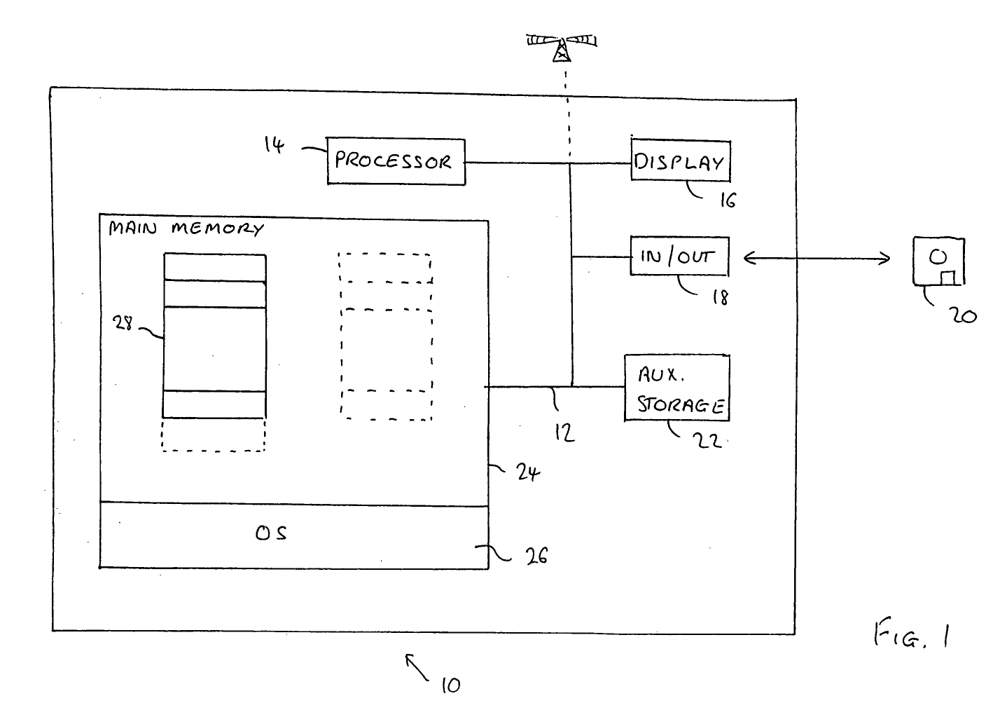

FIG. 1 is a schematic diagram of a computer system on which software protected in accordance with the invention is run;

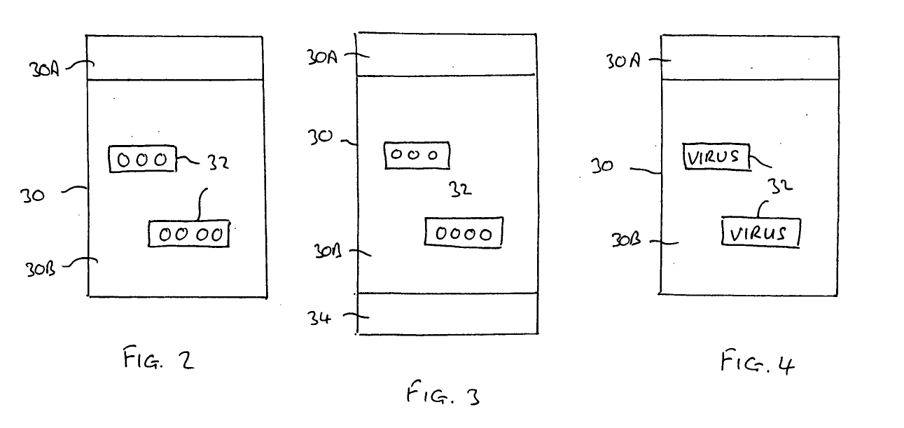

FIGS. 2, 3 and 4 illustrate RAM containing software, and the effects of viruses;

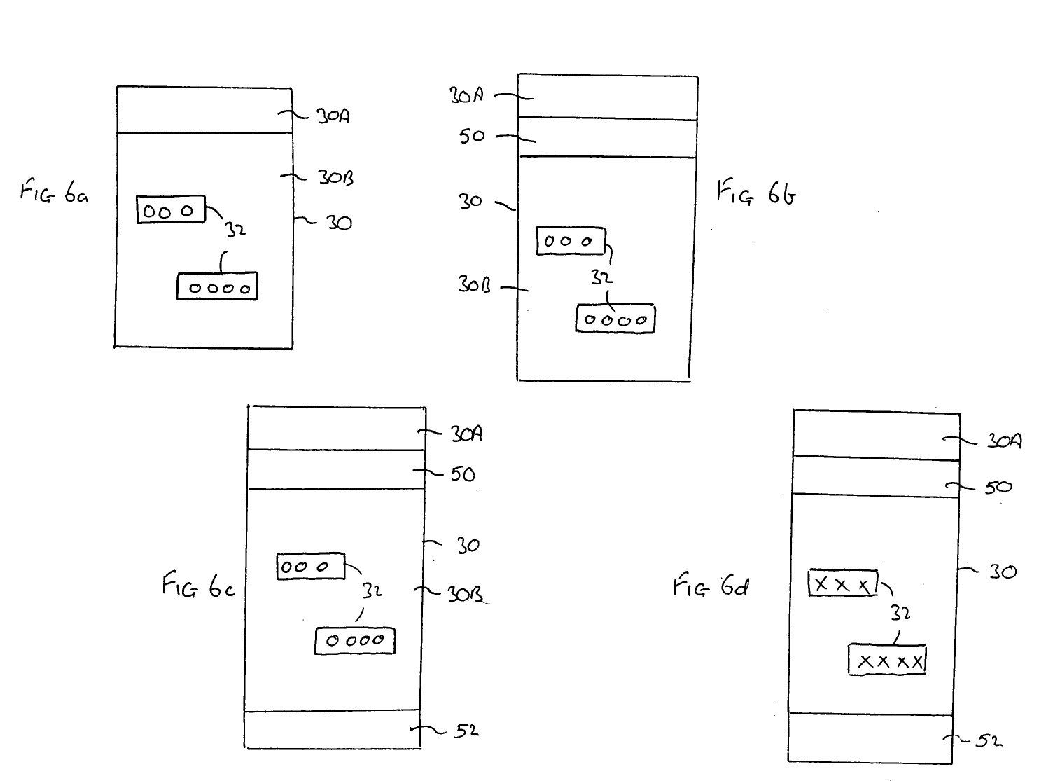

FIG. 5 is a schematic diagram of a computer system by means of which software may be protected in accordance with the present invention; and

FIGS. 6a to 6d illustrate software being modified for protection.

FIG. 1 illustrates a general purpose computer 10, such as an IBM compatible personal computer (PC), which can be operated under software control. Briefly, the computer 10 includes a data bus 12 which interconnects a central processor 14, a display 16, input and output devices 18, auxiliary storage 22, and main memory 24 in the form of random access memory (RAM). The input and output devices 18 may include a keyboard and a disc drive for reading from or writing to a removable storage device such as a floppy disc 20. The storage 22 may be a hard disc drive.

During normal use, the RAM 24 will contain software in the form of an operating system 26, by virtue of which one or more software applications may run. FIG. 1 shows the RAM 24 containing an application 28 which has a structure affording protection to the application in accordance with the invention.

Before describing further the structure 28, it is appropriate to describe the conventional structure of a computer program installed in RAM 26. This structure is illustrated in FIG. 2. FIG. 2 illustrates a region 30 of RAM. The region is divided into two smaller regions, namely a header region 30A and a program region 30B. The program region 30B contains code for execution to implement the application. The header region 30A contains code for execution primarily when the application is first called. For example, the header 30A, when executed, may make security checks to ensure that the program 30B is properly licensed, to check passwords of the user seeking to use the application, and to initialise parameters, flags etc., for commencing operation of the application. Control is then passed to the program region 30B for execution of the application.

Two regions 32 are marked within the program region 30B. These regions are empty. That is, they do not contain any code which contributes to the application, nor are they used at any point in execution of the program 30B for the storage of temporary data. Gaps of this nature are commonly found in applications installed in RAM. They may arise for various reasons, for example from inefficiency in compiler software. The significance of these empty regions will be explained below.

A simple virus may infect a structure 30 in the manner illustrated in FIG. 3. Infection by the virus has resulted in an additional region 34 of executable code, containing the virus. Commonly, a virus will interact with the header 30A to circumvent security procedures of the header 30A and thus allow unlicensed copies of the software to be made and executed. Alternatively, a virus may interact with other functions of the header 30A or program 30B, or with data or software held elsewhere in the computer on which the application 30 is running.

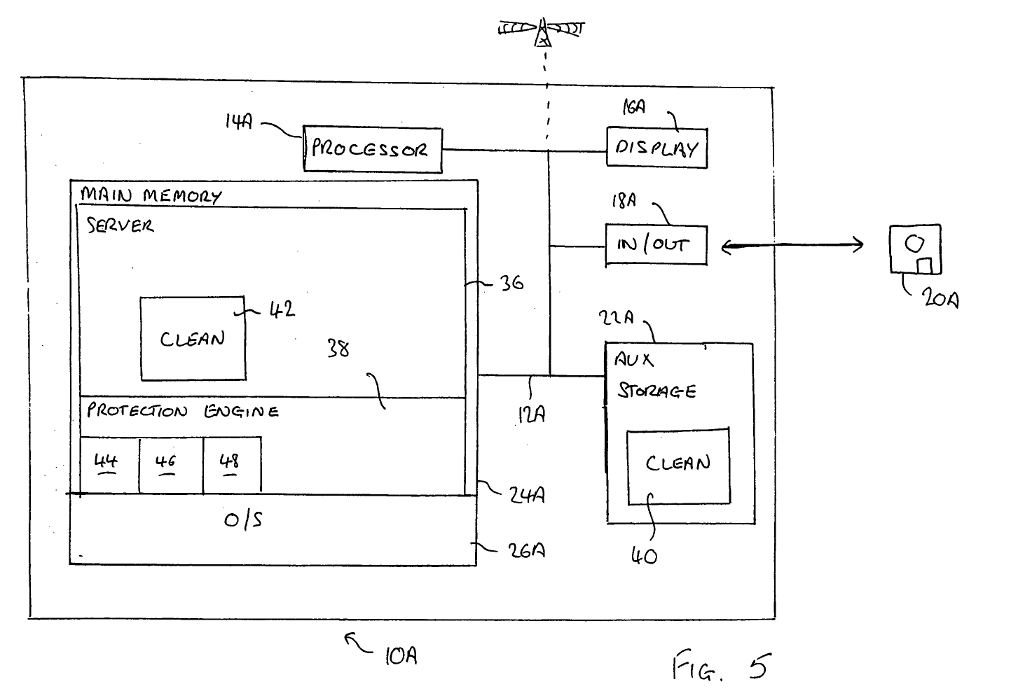

A more sophisticated form of virus may infect an application 30 in the manner illustrated in FIG. 4. In this example, the virus does not appear as a separate region at the end of the application 30, but is embedded within the program region 30B, occupying the regions 32 which should be empty. Part of the infection process implemented by the virus will include the creation of links between the empty regions, so that sections of the virus code are executed in an appropriate order, with control being handed from region to region as the virus executes.

It is readily apparent that a virus embedded in the manner illustrated in FIG. 4 is more difficult to detect than a virus added as a single additional block of software, such as the virus region 34 of FIG. 3.

The present invention seeks to protect software by incorporating the protected program as a module within a computer program structure which serves to provide the protection. Apparatus which can provide this structure will now be described and the program structure will then be described in more detail.

FIG. 5 shows a computer 10A which has a structure similar to the computer 10 of FIG. 1 and will thus not be described in detail, except to note that features of the computer 10A which correspond with features of the computer 10 are given the same reference numerals, with the suffix A. The RAM 24A includes a server program 36 and an application called a protection engine 38. The server program 36 responds to requests for an item of software to be protected. These requests may be made by a user by means of the input/output devices 18A, for example. When the server program 36 receives a request, a copy of the software to be protected is retrieved from auxiliary storage 22A, which contains a copy 40 which is clean, i.e. not affected by virus infection. The clean version 40 is copied by the server program 36 to the RAM 24A at 42. The server program 36 then invokes the protection engine 38 to operate further on the clean copy 42 to provide protection in accordance with the invention.

Within the protection engine 38, there are modules 44, 46, 48 which respectively allow the protection engine 38 to add additional security checks to the copy 42, to execute compression routines on the copy 42, and to identify empty regions within the copy 42. The operation of the protection engine 38, and in particular the modules 44 to 48 can best be described by considering FIG. 5 alongside FIG. 6, which shows the condition of the clean copy 42 at various stages in the process of providing protection.

FIG. 6a corresponds with FIG. 2 and shows the copy 42 in conventional form, as copied from the auxiliary storage 22A. The security check module 44 first operates on the copy 42 to insert an additional block of code 50, shown in FIG. 6b as being located immediately after the header 30A but which could alternatively be located elsewhere. The security block 50 is executable to analyse all or part of the structure 30 to determine whether or not any change has been made to the structure after the creation of the structure in the manner being described. This sensing may be achieved by measuring a parameter of the software, for comparison with a parameter value measured previously. For example, the total size of the block of code could be calculated and recorded, or the size of one or more sections of the code, or a characteristic value calculated from the code or one or more sections of it, such as a cyclic redundancy check (CRC) value or other value of the type commonly calculated for use in encryption and decryption algorithms. Alternatively, the parameter may be the location of a feature such as the original entry point (OEP) at which execution of the code will begin.

Once the parameter has been measured and its value recorded, execution of the security block 50 can thereafter be used to detect any change within the structure, sufficient to change the value of the parameter. For example, if the parameter is the size of the structure, any change which affects the size (such as the attachment of a virus region 34 as shown in FIG. 3) will be revealed when the block 50 next executes. If a virus embeds itself in the manner illustrated in FIG. 4, the overall size of the structure may not change, but a characteristic value such as a CRC value would change and thus this change would be detected when the security block 50 runs. Consideration of a parameter such as the OEP allows the detection of a virus of the type which modifies the OEP, for example to cause the virus to execute when the software is called, or which causes initial operations to be missed.

It will be apparent to the skilled reader that many different parameters could be used to identify different types of change to the structure, and that these parameters could be used individually or in various combinations. In general, it is expected that the strength of protection provided by the invention will increase as the number of parameters checked increases.

The security block 50 is arranged to hand execution to the program 30B in the event that no changes are detected, but to take remedial action to be described, in the event that any change is detected.

The compression module 46 further modifies the copy 42 by attaching a block of compressed code 52 as illustrated in FIG. 6c. FIG. 6c illustrates the compressed code 52 attached to the end of the structure 30, but could be attached elsewhere. The compressed code 52 represents a compressed copy of the program region 30B or, preferably, of the entire region 30 (including itself) and subject to a compression algorithm for which a decompression algorithm is incorporated within the security block 50.

The caving module 48 of the protection engine 38 may operate alone or in conjunction with the modules 44, 46. When operating alone, the caving module 48 seeks to identify any empty regions within the program region 30B, in the manner in which a caving virus would identify these regions 32. Any regions which are found are then filled with meaningless data by the caving module 48. The result is illustrated in FIG. 6d. The regions 32 are no longer empty. The structure 30 is thus protected from infection by a virus which looks for and inserts itself into empty regions 32.

When the caving module 48 is working in conjunction with the modules 44 or 46, some or all of the security block 50 or the compressed code 52 may be incorporated into regions 32 which the module 48 has determined are empty and any regions which thereafter remain empty may be filled with meaningless data as described above.

Once the application has been protected in the manner described, the protected copy can be made available to a user. For example, the copy may be put onto a removable disc 20A, which can then be used to load the protected structure onto the computer 10. Alternatively, the protected version could be transmitted as data over a communication network. FIGS. 1 and 5 schematically illustrate the connection of the computers 10, 10A to a public network such as the internet, by way of example, but other network communication could be established, including a wireless network.

The security block 50 includes a decompression algorithm for the compressed code 52, as has been stated. The decompression algorithm is invoked in the event that the block 50 determines that a change has been made within the structure 30. This change could be indicative of virus infection or other corruption, as noted above. The effect is illustrated schematically in FIG. 1. FIG. 1 illustrates in broken lines the existence of a virus 54 which has infected the application 28 by attaching itself as a stub in the manner illustrated in FIG. 3. When the application 28 is called, security checks made by the block 50 will identify the changes introduced by the virus 54, as has been described. The block 50 will then invoke the decompression algorithm to decompress the code 52 and install a fresh copy of the application 28, preferably at an alternative location 56 within the RAM 24. In addition, it will be necessary for the block 50 to modify any look-up tables held within the operating system 26 to identify the location of the application 28 or its components. Consequently, when the application 28 is again called, the copy at 56 will be executed. Since this has been decompressed from the code 52, which does not include the virus 54, the copy at 56 will not include the virus and is thus clean. The virus 54 remains attached to the original copy of the application at 28, but is now rendered ineffective because the original copy 28 will not be called to execute.

In some circumstances, the provision of compressed code 52 may increase the size of the region 32 an unacceptable degree. This may depend on the degree of compression available. An alternative arrangement allows the protection of the invention to be provided without using a compressed code block 52. In this alternative, the application is modified in the manner illustrated in FIG. 6b, to include the security block 50, but the compressed code 52 is not included. Furthermore, the security block 50 is modified so that, in the event a change is detected, the block 50 initiates communication over a network 58 to which the computer 10 is connected. This communication connects the computer 10 to another computer, such as the computer 10A. The block 50 causes a request to be sent to the computer 10A to identify the application and the computer on which it is installed, and to indicate that a change has been detected and that a fresh copy of the protected application is required.

On receipt of a request of this nature, the server program 36 retrieves a further clean copy of the application from the storage 22A and dispatches it to the computer 10 over the network 58. This copy is preferably dispatched in encrypted form. It may be fully protected, in accordance with the invention, by operation of the protection engine 38 before being dispatched.

It will be apparent that many variations and modifications can be made to the arrangements described above, without departing from the scope of the invention. In particular, the invention may be implemented by means of many different computer languages and on many different hardware and software platforms.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A computer program structure including a program module which is executable, and protection means including a sensing module operable to analyse at least part of the program structure to determine whether or not any change has been made thereto, and a correction module operable to retrieve a further copy of the program module in the event that a change is detected, and to cause the further copy to be executed instead of the first module.

2. The structure of claim 1, wherein the sensing module is operable to measure a parameter of the said part, for comparison with a parameter value measured previously.

3. The structure of claim 2, wherein the parameter is the size of the data representing the said part, or the size of a section of the said data.

4. The structure of claim 2, wherein the parameter is the location of a predetermined feature.

5. The structure of claim 4, wherein the predetermined feature is an entry point for the program module.

6. The structure of claim 2, wherein the parameter is a characteristic value calculated from the code representing the said part, such as a cyclic redundancy check (CRC) value.

7. The structure of claim 1, wherein the correction module includes the said further copy.

8. The structure of claim 7, wherein the said further copy is held in compressed form within the correction module.

9. The structure of claim 1, wherein the correction module, in use, retrieves the further copy from a location remote from the machine on which the program module is to be executed.

10. The structure of claim 9, wherein the further copy is retrieved, in use, by means of data transmission over a network, such as a wireless network.

11. The structure of claim 1, wherein the correction module installs the further copy at a location alternative to the location of the program module.

12. The structure of claim 1, wherein the sensing module and/or the correction module are incorporated with the program module to form a single procedure.

13. The structure of claim 1, wherein the sensing module and/or correction module are contained wholly or partly within a header to the procedure.

14. The structure of claim 12, wherein the sensing module and/or correction module are contained wholly or partly at empty locations within the program module.

15. The structure of claim 14, wherein all other empty locations are filled with meaningless data.

16. A method of executing a computer program, in which at least part of the copy of the program available for execution is analysed to determine whether or not any change has been made thereto, and in the event that a change is detected, a further copy of the program is retrieved and caused to be executed instead of the first copy.

17. The method of claim 16, wherein a parameter of the said part is measured, for comparison with a parameter value measured previously.

18. The method of claim 17, wherein the parameter is the size of the data representing the said part, or the size of a section of the said data.

19. The method of claim 17, wherein the parameter is the location of a predetermined feature.

20. The method of claim 19, wherein the parameter is an entry point for the program copy.

21. The method of claim 17, wherein the parameter is a characteristic value calculated from the code representing the said part, such as a cyclic redundancy check (CRC) value.

22. The method of claim 16, wherein the computer program is associated with a correction module which includes the said further copy.

23. The method of claim 22, wherein the further copy is held in compressed form within the correction module.

24. The method of claim 16, wherein the correction module retrieves the further copy from a location remote from the machine on which the program module is to be executed.

25. The method of claim 24, wherein the further copy is retrieved by means of data transmission over a network, such as a wireless network.

26. The method of claim 16, wherein the correction module installs the further copy at a location alternative to the location of the said first copy.

27. The method of claim 16, wherein a sensing module operable to determine whether or not any change has been made and/or the correction module are incorporated within the program module to form a single procedure.

28. The method of claim 27, wherein the sensing module and/or correction module are contained wholly or partly within a header to the procedure.

29. The method of claim 27, wherein the sensing module and/or correction module are contained wholly or partly at empty locations within the procedure.

30. The method of claim 29, wherein all other empty locations are filled with meaningless data.

31. Apparatus operable to create a computer program structure, the apparatus being operable to provide an executable program module and protection means which includes a sensing module operable to analyse at least part of the program structure to determine whether or not any change has been made thereto, and a correction module operable to retrieve a further copy of the program module in the event that a change is detected, and to cause the further copy to be executed instead of the first module.

32. The apparatus of claim 31, wherein the sensing module is operable to measure a parameter of the said part, for comparison with a parameter value measured previously.

33. The apparatus of claim 32, wherein the parameter is the size of the data representing the said part, or the size of a section of the said data.

34. The apparatus of claim 32, wherein the parameter is the location of a predetermined feature.

35. The apparatus of claim 34, wherein the feature is an entry point for the program module.

36. The apparatus of claim 32, wherein the parameter is a characteristic value calculated from the code representing the said part, such as a cyclic redundancy check (CRC) value.

37. The apparatus of claim 31, wherein the correction module includes the said further copy.

38. The apparatus of claim 37, wherein the said further copy is held in compressed form within the correction module.

39. The apparatus of claim 31, wherein the correction module is operable to retrieve the further copy from a location remote from the machine on which the program module is to be executed.

40. The apparatus of claim 39, wherein the further copy is retrieved by means of data transmission over a network, such as a wireless network.

41. The apparatus of claim 31, wherein the correction module installs the further copy at a location alternative to the location of the program module.

42. The apparatus of claim 31, wherein the sensing module and/or the correction module are incorporated within the program module to form a single procedure.

43. The apparatus of claim 42, wherein the sensing module and/or correction module are contained wholly or partly within a header to the procedure.

44. The apparatus of claim 43, wherein the sensing module and/or correction module are contained wholly or partly at empty locations within the program module.

45. The apparatus of claim 44, wherein all other empty locations are filled with meaningless data.

46. A method of creating a computer program structure, in which an executable program module is provided and is associated with protection means which includes a sensing module operable to analyse at least part of the program module to determine whether or not any change has been made thereto, and a correction module operable to retrieve a further copy of the program module in the event that a change is detected, and to cause the further copy to be executed instead of the first module.

47. The method of claim 46, wherein the sensing module is operable to measure a parameter of the said part, for comparison with a parameter value measured previously.

48. The method of claim 47, wherein the parameter is the size of the data representing the said part, or the size of a section of the said data.

49. The method of claim 47, wherein the parameter is the location of a predetermined feature.

50. The method of claim 49, wherein the feature is an entry point for the executable part.

51. The method of claim 47, wherein the parameter is a characteristic value calculated from the code representing the said part, such as a cyclic redundancy check (CRC) value.

52. The method of claim 46, wherein the correction module includes the said further copy.

53. The method of claim 52, wherein the said further copy is held in compressed form within the correction module.

54. The method of claim 46, wherein the correction module is operable to retrieve the further copy from a location remote from the machine on which the program module is to be executed.

55. The method of claim 54, wherein the further copy is retrieved by means of data transmission over a network, such as a wireless network.

56. The method of claim 46, wherein the correction module is preferably operable to install the further copy at a location alternative to the location of the first module.

57. The method of claim 46, wherein the sensing module and/or the correction module are incorporated within the program module to form a single procedure.

58. The method of claim 57, wherein the sensing module and/or correction module may be contained wholly or partly within a header to the procedure.

59. The method of claim 58, wherein the sensing module and/or correction module are contained wholly or partly at empty locations within the program module.

60. The method of claim 59, wherein all other empty locations are filled with meaningless data.
